(19) United States
(12) Patent Application Publication
(10) Pub. No.: US 2013/0191194 A1
(43) Pub. Date: Jul. 25, 2013

(54) METHOD FOR INCENTIVIZING FINANCIAL SAVING AND EFFECTING A FINANCIAL BEHAVIOR CHANGE

(71) Applicants: Sammy Shreibati, Los Altos, CA (US); Priya Karim Haji, San Francisco, CA (US)

(72) Inventors: Sammy Shreibati, Los Altos, CA (US); Priya Karim Haji, San Francisco, CA (US)

(21) Appl. No.: 13/601,103

(22) Filed: Aug. 31, 2012

Related U.S. Application Data
(60) Provisional application No. 61/530,900, filed on Sep. 2, 2011.

(51) Int. Cl. G06Q 30/02

(52) U.S. Cl. CPC G06Q 30/0209
USPC 705/14.12

(57) ABSTRACT

One variation of a method for incentivizing financial saving includes: monitoring multiple financial accounts of a user; identifying a monetary transfer within the financial accounts that increases net user worth within the financial accounts; awarding a nonmonetary credit to the user based upon the monetary transfer; exchanging the credit for a user game play within a game; and issuing a prize associated with the game to the user in response to a user game play win.

### CROSS-REFERENCE TO RELATED APPLICATIONS

This application claims the benefit of U.S. Provisional Application No. 61/530,900, filed 2 Sep. 2011, which is incorporated herein in its entirety by this reference.

### TECHNICAL FIELD

This invention relates generally to the field of financial management, and more specifically to new and useful methods for incentivizing monetary saving and effecting a financial behavior change in the field of financial management.

### BACKGROUND

Online access to bank accounts has enabled a wide range of savings and personal finance management services to compliment perks issued by banks and other financial institutions that reward customers spending and consumption. For example, web-based personal finance management services such as mint.com have enabled users to track total monetary worth over multiple financial accounts and have educated users with saving tips. However, although such services provide financial education, they do not incentivize or reward customer adoption of these saving tips.

Thus, there is a need to create new and useful methods for incentivizing monetary saving and effecting a financial behavior change in the field of financial management.

### BRIEF DESCRIPTION OF THE FIGURES

FIG. 1 is a flowchart representation of a first method;

FIG. 2 is a flowchart representation of one variation of the first method;

FIG. 3 is a flowchart representation of one variation of the first method;

FIG. 4 is a flowchart representation of one variation of the first method;

FIG. 5 is a flowchart representation of a second method;

FIG. 6 is a flowchart representation of one variation of the second method;

FIG. 7 is a flowchart representation of one variation of the second method;

FIG. 8 is a flowchart representation of one variation of the second method;

FIG. 9 is a schematic representation of an output in accordance with a method; and

FIG. 10 is a schematic representation of an output in accordance with a method.

### DESCRIPTION OF THE PREFERRED EMBODIMENTS

The following description of the preferred embodiment of the invention is not intended to limit the invention to these preferred embodiments, but rather to enable any person skilled in the art to make and use this invention.

### 1. Method for Incentivizing Financial Saving

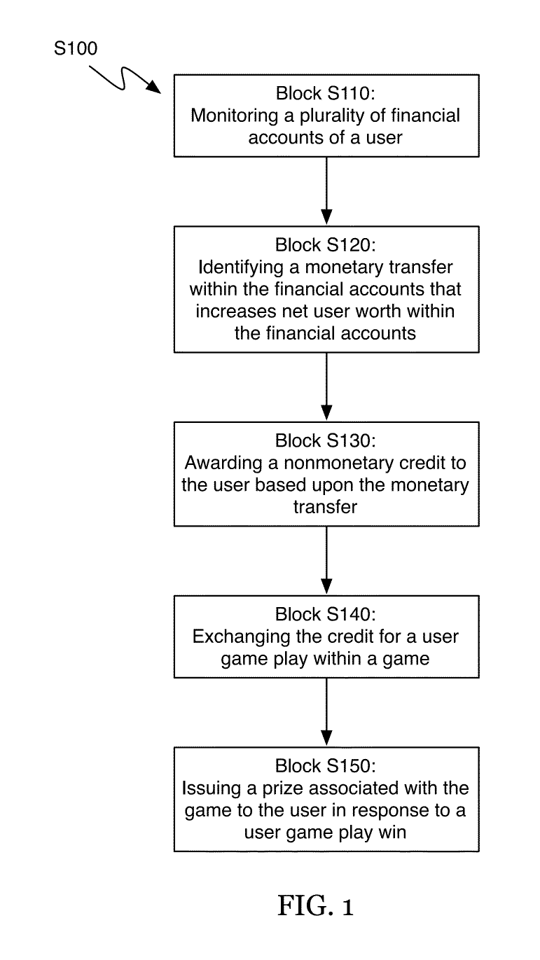

As shown in FIG. 1, a method S100 for incentivizing monetary saving includes: monitoring multiple financial accounts of a user in Block S110; identifying a monetary transfer within the financial accounts that increases net user worth within the financial accounts in Block S120; awarding a nonmonetary credit to the user based upon the monetary transfer in Block S130; exchanging the credit for a user game play within a game in Block S140; and issuing a prize associated with the game to the user in response to a user game play win in Block S150.

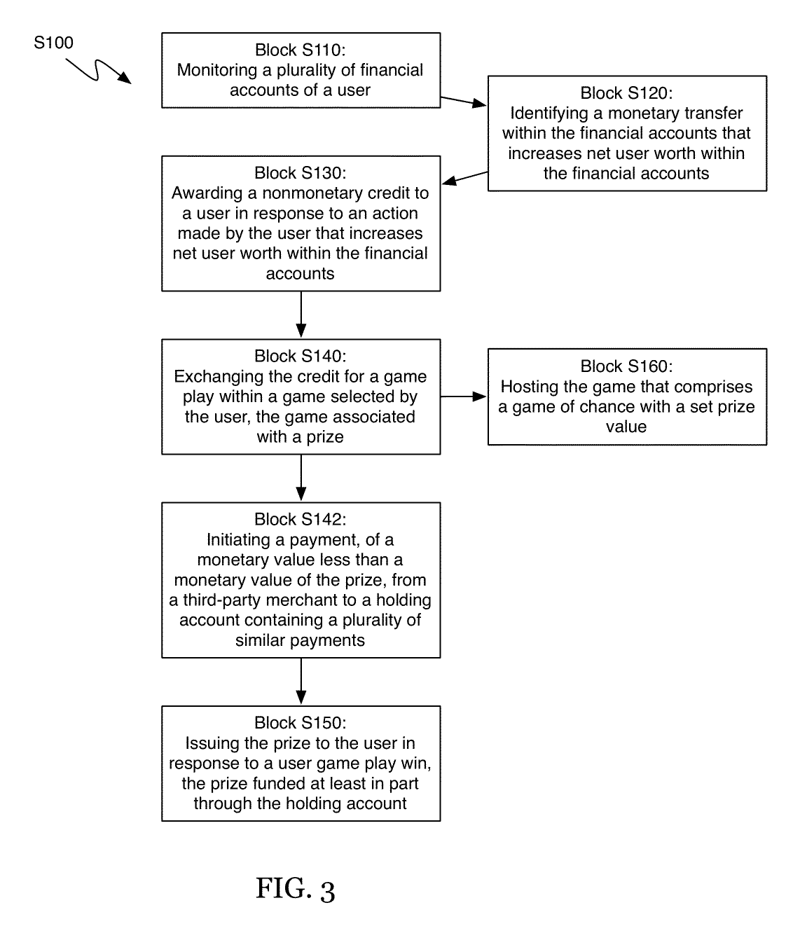

As shown in FIG. 3, method S100 for incentivizing monetary saving can similarly include: monitoring a plurality of financial accounts of a user in Block S110; awarding a nonmonetary credit to a user in response to an action made by the user that increases net user worth within the financial accounts in Block S130; exchanging the credit for a game play within a game selected by the user in Block S140, the game associated with a prize; initiating a payment, of a monetary value less than a monetary value of the prize, from a third-party merchant to a holding account containing a plurality of similar payments in Block S142; and issuing the prize to the user in response to a user game play win in Block S150, the prize funded at least in part through the holding account.

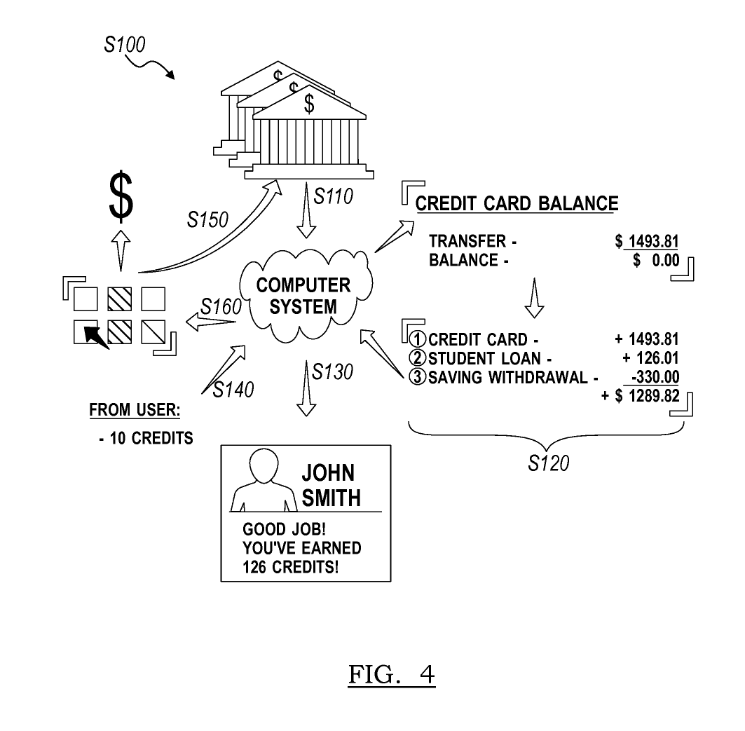

Method S100 preferably functions to incentivize financial savings and mitigation of debt by rewarding the user with credits that are redeemable for various prizes, tickets, and/or games. As shown in FIG. 4, method S100 is preferably implemented by a computer system that monitors multiple financial accounts of a user, identifies financial actions taken by the user to increase net monetary worth of the user, and rewards the user for the positive financial action. The computer system is preferably cloud-based (e.g., Amazon EC₃), but can alternatively be a mainframe computer system, a grid-computer system, or any other suitable computer system. The computer system preferably communicates with the user through a web browser or native application executing on an electronic device, such as a smartphone, a tablet, a laptop computer, a desktop computer, a personal data assistant, or an Internet-enabled personal music player. Method S100 is preferably implemented by an entity separate and distinct from a financial institution (e.g., a bank), although method S100 can be implemented directly by a bank (e.g., in the form of a customer perk) or by any other suitable entity.

Generally, method S100 preferably rewards the user for saving more and reducing debt rather than rewarding the user for spending more or increasing debt. Method S100 preferably rewards the user through issued credits that are redeemable for game plays in sweepstakes-type games. The credit therefore preferably does not qualify as ‘consideration’ under applicable sweepstakes and contests laws, such as local, state, or federal sweepstakes and contests laws in the United States of America. Generally, method S100 preferably does not require a monetary transaction, deposit, purchase, or other transfer of value from the user to the computer system or associated entity to qualify for the credit. The credit is therefore preferably monetarily-free to the user such that method S100 can yield only a net monetary or worth increase for the user. Notably, method S100 preferably monitors financial transactions within the user financial accounts, such as transferring money out of a checking account to pay off a student loan or to boost a savings account, wherein the financial transactions do not include a payment to the computer system implementing method S100 or associated entity in exchange for the credit such that the financial transactions do not qualify as consideration.

Method S100 preferably maintains a non-financial account (a ‘gaming account’) for the user such that the user can link financial accounts, review credits, select and/or play games, access prizes, etc. from native applications and/or web browsers executing on a multiple mobile and/or static (e.g., desktop) electronic devices. The user can preferably access additional information from the gaming account, such as consumption or financial behavior recommendations, tracked trends in user monetary spending, saving, and debt, or financial statuses or trends of other users. However, when implemented directly by a bank or other financial institution in which the user holds a financial account, method S100 preferably enables an additional feature accessible by the user through the user financial account online (e.g., accessible through a browser or native application on a mobile electronic device).

Block S110 of method S100 recites monitoring multiple financial accounts of the user. Because method S100 preferably awards the credit to the user based upon a monetary transfer within the user financial accounts that increases net user worth, Block S110 preferably maintains a substantially accurate, holistic image of the financial status of the user by monitoring multiple user financial accounts. By developing a substantially comprehensive picture of the financial status of the user in Block S110, debt transfer between financial accounts can be discerned from positive attempts to reduce user debt, increase savings, and/or augment investments in Block S120, and positive attempts to reduce user debt, increase savings, and/or augment investments can be rewarded in Block S130 to incentivize such positive financial actions by the user. For example, Block S110 can track a checking account, a savings account, and a two credit card accounts of the user, and Block S120 can identify a monetary transfer from one credit card to a second credit card as debt transfer and can identify a monetary transfer from a checking account to a student loan account as a positive attempt to reduce user debt. In this example, Block S130 preferably awards the credit to the user for the positive attempt to reduce debt but not for the debt transfer. However, Block S110 can include monitoring (e.g., tracking) additional or alternative user financial accounts, such as a student loan account, a mortgage, an Independent Retirement Account (IRA), a car loan account, public or private stock holdings, or bonds held by the user.

Block S110 preferably accesses financial accounts linked or specified by the user. For example, the user can enter account and routing numbers to link a checking account to the user gaming account, such as through a native application or web browser, and the user can enter a username and password (e.g., ‘login’ credentials) associated with a credit card company to link a respective credit card account to the user gaming account. Method S100 preferably extracts user debt, available funds, investment holdings, and/or any other relevant monetary information from the linked accounts, though method S100 preferably excludes modifying, manipulating, or transferring funds to, from, or within the user's financial accounts. Block S110 therefore preferably accesses user financial accounts through read-only Internet-based connections to databases of respective financial institutions, as shown in FIG. 4. (However, Block S110 can alternatively access user financial accounts through read-write connections, such in a variation of the method S100 that automatically manipulates user financial accounts to improve net worth of the user). Block S110 preferably repeatedly or constantly mines a user financial account for monetary transfers, charges, pending charges, cancelled charges, pending deposits, pending payments, returns, or any other change, such as according to a set update schedule. Additionally or alternatively, Block S110 can access a user financial statement once published by a bank or other financial institution, can analyze a user financial transaction when notified or alerted by a financial institution, can access user financial data once scraped or collected by a third party, or can access, monitor, and/or analyze any other user financial transaction according to any other timing, alert, or schedule.

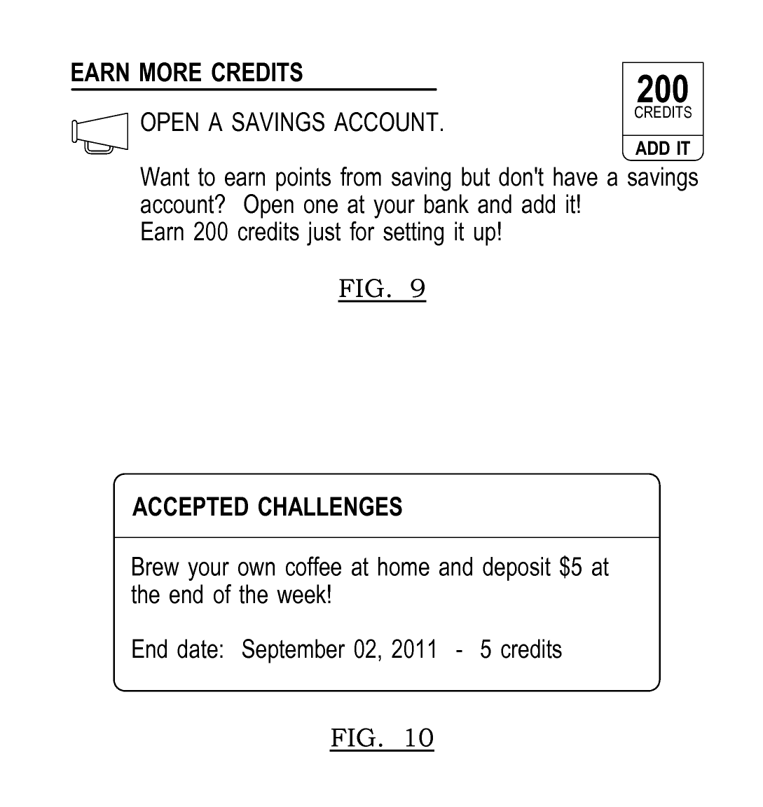

As shown in FIG. 9, Block S110 can further incentivize the user to add or link a financial account by issuing one or more credits to the user for each account added. Block S110 can allocate credits for the user based upon a hierarchical account model, such as by issuing one credit to the user for linking a checking account, two credits for linking a student loan account, and three credits for linking a savings account. However, Block S110 can function in any other way to monitor multiple financial accounts of the user.

Block S120 of method S100 recites identifying a monetary transfer within the financial accounts that increases net user worth within the financial accounts. As described above, Block S120 preferably analyzes financial transactions, made by or on behalf of the user, that reduce debt and/or increase net financial worth of the user across the user financial accounts. Therefore Block S120 preferably determines the source, destination, type, and magnitude of a financial transaction made by the user. For example, Block S120 can analyze a transaction captured in Block S110 to identify the origin of a monetary transfer as a user checking account, to identify the destination of the monetary transfer as a student loan account, to identify the type of the monetary transfer as a student loan payment, and to identify the magnitude of the monetary transfer as a dollar amount (e.g., $350). In this example, Block S130 preferably issues a credit to the user as reward for increasing net user worth by reducing net user debt. In another example, Block S120 can analyze a transaction captured in Block S110 to identify the origin of a monetary transfer as a user credit card account, to identify the destination of the monetary transfer as a mortgage account, to identify the type of the monetary transfer as a mortgage payment, and to identify the magnitude of the monetary transfer as a dollar amount (e.g., $2,750). In this example, Block S130 preferably withholds a credit from the user because net user worth was unchanged or diminished (e.g., by fees or interest charges) by the monetary transfer.

Similarly, Block S120 can include identifying a monetary transfer within the financial accounts that positively impacts user debt and/or long term worth of the user. For example, Block S120 can identify a home mortgage payment by the user as a positive financial transaction because, though the actual net worth of the user diminished in the short term (e.g., more of the payment went to interest than to equity in the home), the user is near to owning the home outright in the long term as a result of the mortgage payment. In another example, Block S120 can identify a credit card payment by the user as a positive financial transaction because, though the actual user net worth (i.e. net debt and liquid funds) did not change in the short term, the net worth of the user improved in the long term because the user will avoid paying interest on the now-clear debt in the future. Therefore, Block S120 can account for the effect of a financial transaction on the user in the short term (e.g., days or weeks), in mid term (e.g., weeks or months), and/or in the long term (e.g., months or years).

Block S120 therefore preferably analyzes multiple (or all) financial accounts linked by the user to determine a net or overall impact of a monetary transaction on user worth. However, Block S120 can further incorporate a time component, wherein Block S120 identifies monetary transfers within a specified period of time that increase net user worth within the user financial accounts. For example, Block S120 can sum all or a subset of user financial transactions in one week, in one month, over a year, between pay cycles, between bank statements, over the term of a car loan, etc. to calculate net user worth changes over multiple transactions with the period of time. Block S120 can therefore track trends in user financial behavior over time and identify global (e.g., longer-term) financial characteristics of the user, which can serve as a more accurate model or predictor of user financial behavior than isolated user financial transaction events. Generally, Block S130 preferably rewards the user with a credit when Block S120 identifies a net increase in user financial worth over the period of time, and Block S130 preferably withholds a credit from the user when Block S120 identifies a net decrease in user financial worth over the period of time. However, Block S140 can function in any other way to identify a monetary transfer within the financial accounts that increases net user worth.

Block S130 of method S100 recites awarding a nonmonetary credit to the user based upon the monetary transfer. As described above, Block S130 rewards the user with a credit when Block S120 identifies a net increase in user financial worth associated with a user financial transaction, and Block S130 preferably withholds a credit from the user when Block S120 identifies a net decrease in user financial worth associated with a user financial transaction. Block S130 preferably awards a magnitude of nonmonetary credit that corresponds to the magnitude of a net increase in user worth. For example, Block S130 can reward a user credit card payment of $1,000 with 500 credits, whereas Block S130 can reward a user monetary transfer of $50 into a savings account with 25 credits. Additionally or alternatively, Block S130 can award a magnitude of credits that corresponds to a type of destination account and/or a cost (e.g., interest rate, return rate) of a source or destination account. For example, Block S130 can award woo credits to the user for a credit card payment of $1,000 to a credit card with a 18% interest rate, 800 credits to the user for a credit card payment of $1,000 to a credit card with a 12% interest rate, 500 credits to the user for a mortgage payment of $1,000 on a 4.5% mortgage, and 200 credits for a savings account deposit of $1,000 for a savings account that returns .05%. Similarly, Block S130 can award more credits to the user for paying off a debt or loan from a checking account than from a savings account. However, Block S130 can award a magnitude of credits corresponding to any other detail or characteristic of a monetary transfer made by the user.

Block S130 preferably awards the user with the credit that is a nonmonetary, digital credit that is exchangeable for a game play within a game, as shown in FIG. 4. Block S130 preferably stores the credit in a digital credit bank within the gaming account of the user until Block S140 exchanges one or more user credits for a game play, such as based upon a user game selection in Block S170, as shown in FIG. 4. Generally, the credit preferably holds no monetary value, cannot be exchanged for monies or an item of monetary value, and is not directly available for purchase by the user through an exchange of one or more credits. The credit is therefore preferably a free token earned through positive financial behavior (e.g., saving, paying debts, investing) and exchangeable for a game play. Generally, allocation of the credit in Block S130 preferably resolves any consideration (i.e. consideration in lottery, sweepstakes, and contest law) from a direct exchange between the user and the computer system, etc. that implements method S100 such that Block S140 can legally exchange the credit for a user game play in a sweepstakes-type game.

Block S130 can additionally retract credits from the user, such as when one or more negative or poor financial actions are identified in Block S120. However, Block S130 can function in any other way any according to any other schema to award and/or retract a nonmonetary credit to and/or from the user.

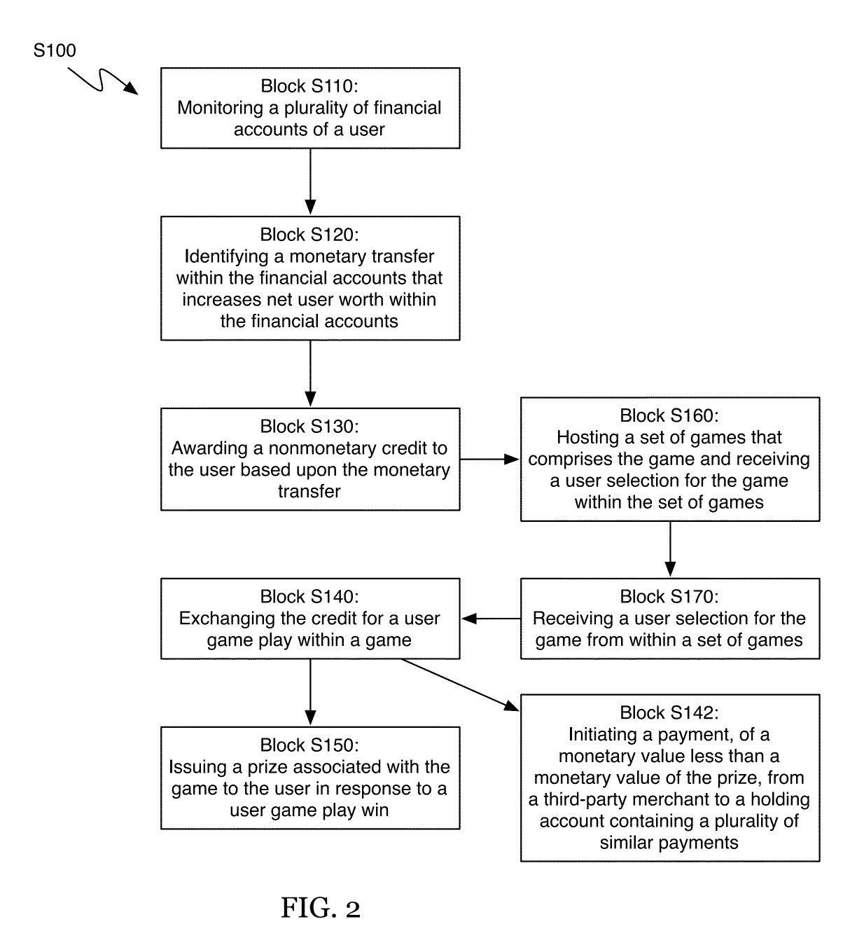

As shown in FIGS. 2, 3, and 4, one variation of method S100 includes Block S160, which recites hosting the game that includes a game of chance with a set prize value. In this variation, the computer system, etc. implementing method S100 preferably enables user access to the game from within the user gaming account. For example, the user can open his gaming account within a website accessed through a web browser or from within a native application executing on a mobile electronic device (e.g., a smartphone). By hosting the game in Block S160, method S100 can substantially seamlessly integrate a financial behavior monitoring service and a credit allocation service with a gaming experience to minimize barriers to a user exchange of a credit for a game play.

Generally, the game is preferably an online game or game played within a native gaming application executing on an (mobile) electronic device such that method S100 does not necessitate tangible (e.g., paper) credits or tickets for game plays. Game outcome (i.e. a win or a loss) for a single game play is preferably wholly independent of user skill and the number of game plays converted by the user, though win probability can be dependent upon a total number of game plays for the game over all users. Therefore, the probability that a game play will result in a win is preferably substantially equal for each game play for all users.

As described above, the game is preferably a sweepstakes-type game with a set prize value for a win and a set win probability (e.g., 1:2.5M, 1:175 M) per game play. In one example implementation, the game is a jackpot drawing in which the user exchanges one or more credits for a set of numbers, wherein the user wins the jackpot if the set of numbers matches a set of draw numbers. The set of numbers can be selected by the user or automatically pseudorandomly selected by the computer system on behalf of the user. Furthermore, in this example implementation, game play outcome determination is preferably delayed over an extended period of time after the user exchanges a credit for a ticket, such as a day, a week, or a month later. For example, the game can be a $2M jackpot drawing in which the user must match six different numbers ranging from 1 to 73 with six future draw numbers to win the jackpot, wherein the odds of a winning ticket (i.e. set of numbers in one game play) is constant at [1 in (73/6*72/5*71/4*70/3*69/2*68/1)] or [1 in 170,230,452]. In this example, the user preferably exchanges the one or more credits for the jackpot ticket during an entry period of a month, and the winning numbers are drawn only upon the close of the entry period. In another example implementation shown in FIG. 4, the game is a digital scratchers-type game in which a win for a single scratcher play is pseudorandomly selected, based upon a set win probability, prior to initiation of the game play by the user. In this example implementation, the outcome of the game play is preferably presented to the user substantially soon after the user plays the game (e.g., digitally scratches on the digital scratcher). For example, the user can exchange one or more credits for a scratcher for a $10,000 cash prize with a win probability of 1:10 M, wherein the scratcher requires the user to uncover hidden symbols associated with one or more prizes. In this example, the outcome of the game is predetermined based upon the win probably, and method S100 updates scratcher areas according to a preset scratcher pattern such that the user immediately knows the outcome of the game play once the game play is complete. In these example implementations, the game win probability is preferably correlated with a monetary value of the prize associated with the game. For example, a single game play for a $2M jackpot can have a one in 170,230,452 chance of being a winning play, wherein a single game play for a $200 prize can have a one in 10,000 chance of being a winning play. In the foregoing example implementations, a game win within a pool of users is preferably not guaranteed over a game period and is instead substantially a matter of chance.

Alternatively, the game can be a drawing-type game with a variable win probability inversely correlated with a number of issued game plays to the user and to other users with similar gaming accounts. The user can exchange one or more credits for a drawing ticket for a drawing game, wherein one ticket is selected from the set of entered tickets at the end of a drawing period or when the number of drawing tickets has reached a maximum. For example, the drawing can be for a new car valued at $25 k, wherein the drawing is held over the course of thirty days, and wherein a single drawing ticket is selected at the conclusion of the thirty days to conclusively identify a single winner of the new car. Therefore, the drawing-type game can guarantee a winning game play at the expiration of each drawing period. The prize for the drawing-type game is preferably predetermined and independent of the number of game plays entered by the user and other users with similar gaming accounts. Furthermore, the value of the prize can increase with an increasing number of game plays within a group of users or adjust according to any other factor. However, the game can be any other suitable type of game, and the game can be implemented in any other way.

Furthermore and as shown in FIG. 3, Block S160 can include hosting any number of games, such as a set of games including the game. The set of games are preferably of different types (e.g., a jackpot, a scratcher, a drawing), of different prize values (e.g., $100, $10,000, $1,000,000), and of different prize types (e.g., cash, a car, a gift card, a vacation, an e-reader, a shopping spree). However, Block S160 can include hosting any other number of games of any other type and with any other type of prize of any other value.

Block S140 of method S100 recites exchanging the credit for the user game play within the game. As described above, method S100 preferably stores credits issued to the user until the user elects to exchange one or more credits for a game play within a game. When the exchange is initiated, Block S140 preferably debits the user a number of credits specified for a game play in the game and initiates the game play for the user. Alternatively, Block S140 can issue a game play ticket to the user.

As shown in FIG. 4, one variation of method S100 can therefore include Block S170, which recites receiving a user selection for the game from within a set of games. In the variation of method S100 in which Block S160 includes hosting multiple games, Block S170 preferably captures a selection for a particular game such that Block S140 can exchange the credit for the user game play within the particular selected game. Block S140 can further exchange the credit for user game plays both within games hosted through Block S160 and within games hosted by or on external websites, servers, networks, and/or computer systems. Block S140 can therefore enable credit exchanges across multiple gaming and/or financial platforms in return for user game plays in game hosted by multiple sources or systems.

As shown in FIG. 4, in the variation of method S100 in which the game is hosted through Block S160, a third-party merchant preferably funds the prize associated with the game. Generally, the prize preferably has a monetary value, though user eligibility to win the prize is preferably not contingent upon a monetary transaction from the user to the game host (e.g., the computer system). Therefore, the third-party entity preferably sponsors the prize. In one example implementation, Block S140 (or Block S142, shown in FIG. 2) initiates an insurance payment from the third-party merchant to an insurance account associated with the prize, such as a lottery insurance account. The magnitude of the insurance payment preferably correlates with the monetary value of the prize and an evaluated (i.e. actuarial) risk of the user game play resulting in a win, and the insurance payment is therefore preferably of a monetary value less than the monetary value of the prize. In this example implementation, Block S140 preferably transfers the insurance payment into the insurance account that aggregates the insurance payment with previous insurance payments also initiated via Block S140 for previous game plays for the user and/or for other users with similar gaming accounts. When a game play results in a win, funds in the insurance account can then be used to fund the prize. In another example implementation, when the user elects a game play in a game sponsored by the third-party entity, Block S140 triggers the third-party entity to transfer a fund into a private holding account held by the third-party entity. In this variation, the magnitude of the fund also preferably correlates with the monetary value of the prize and an evaluated (i.e. actuarial) risk of a game play resulting in a win. Given a game play win, the third-party can transfer funds out of the holding account to pay for or subsidize the prize. Alternatively, the third-party entity can allocate a full value of the prize to a holding account prior to opening the game for user game plays. However, the third-party entity can fund or sponsor the prize in any other suitable way, and the holding account can be any static account, investment account, insurance account, or other account that holds and/or grows funds in anticipation of a user game play win.

In the variation of method S100 in which the third-party entity sponsors or funds the prize associated with the game, the prize is preferably related to a product or service offered by the third-party merchant. For example, an automobile manufacturer can sponsor a prize that is a new car, a consumer electronics vendor can sponsor a prize that is a new cellular phone, and an airline company can sponsor a prize that is an international flight. In the variation of method S100 including Block S160 that hosts multiple games, each game is preferably associated with a unique prize, and each game is preferably advertised to the user by displaying the associated prize. Each game can also be advertised by displaying a name or brand of the third-party entity that sponsors the game. However, the prize can be any other type of prize, sponsored by any other third-party entity, and advertised to the user in any other way.

Block S150 of method S100 recites issuing the prize associated with the game to the user in response to a user game play win. Block S150 can issue the prize to the user in any of a variety of ways. In one example implementation, Block S150 issues a monetary prize to the user by transferring winnings directly into a financial account linked by the user, such as a savings or checking account, as shown in FIG. 4. In another example implementation, Block S150 issues the monetary prize to the user by indicating to the user that he has won the game and triggering an external party to deliver the prize to the user, such as in the form of a check written by an insurance company that holds the insurance account or by the third-party entity that maintains the holding account. In another example implementation, Block S150 issues the prize to the user by collecting user contact information, informing the third-party entity, and informing the user to schedule an appointment with the third-party entity to collect the prize. Block S150 can therefore include delivering the prize to the user directly, triggering the third-party entity or other external entity to deliver the prize, and/or enabling the user to collect the prize. However, Block S150 can function in any other way to issue the prize or trigger issuance of the prize to the user.

Block S150 can further tabulate local, state, and/or federal taxes and withholdings legally required to be paid before the prize is delivered to the user. Block S150 can further issue these requisite taxes and withholdings to applicable tax boards. For example, Block S150 can transfer 25% of a cash prize to the federal government, ˜8% to the state government, and ˜3% to the city government in which the user resides prior to issuing the remaining 64% of the cash prize to the user. In another example, for a prize for a vehicle valued at $25 k, Block S150 can transfer funds from linked financial accounts of the user to requisite tax boards to cover local, state, and/or federal tax requirements. However, Block S150 can function in any other way to fulfill legal obligations associated with transferring the prize to the user.

### 2. Method for Effecting a Financial Behavior Change

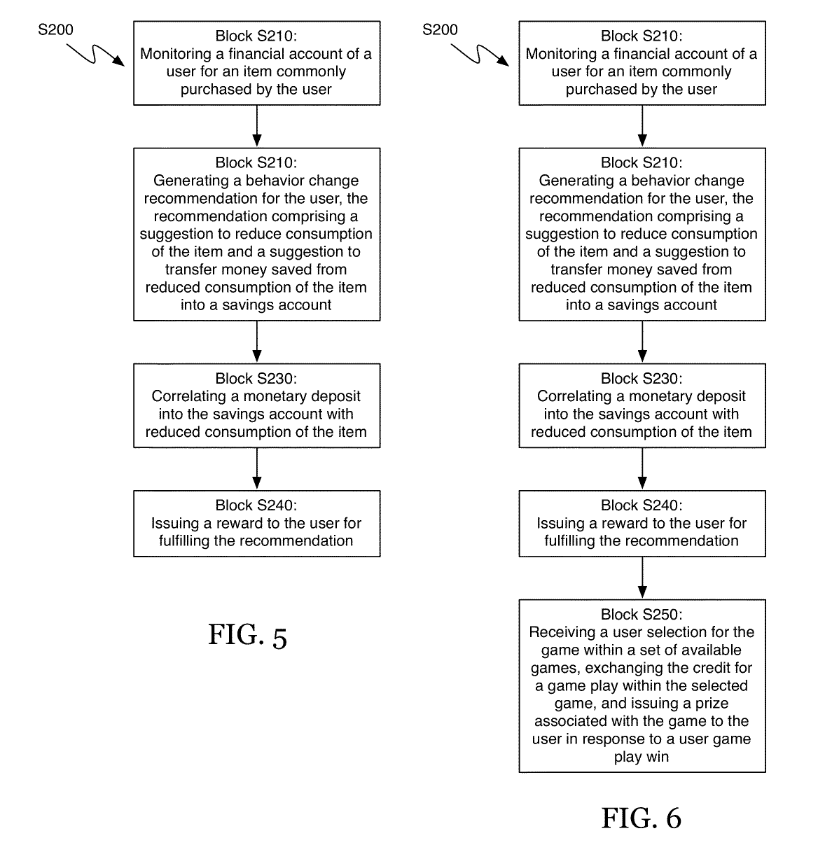

As shown in FIG. 5, a method S200 for effecting a financial behavior change includes: monitoring a financial account of a user for an item commonly purchased by the user in Block S210; generating a behavior change recommendation for the user in Block S220, the recommendation including a suggestion to reduce consumption of the item and a suggestion to transfer money saved from reduced consumption of the item into a savings account; correlating a monetary deposit into the savings account with reduced consumption of the item in Block S230; and issuing a reward to the user for fulfilling the recommendation in Block S240.

Method S200 preferably functions to incentivize positive financial behavior of a user by rewarding the user for realizing recommendations related to financial behavior. Method S200 is preferably implemented in conjunction with method S100, wherein method S100 incentivizes positive global asset management and method S200 incentivizes financial behavior changes related to more specific user purchases or behaviors. Method S200 is therefore preferably accessible by the user through the user gaming account described above, though method S200 can be implemented separately from method S100.

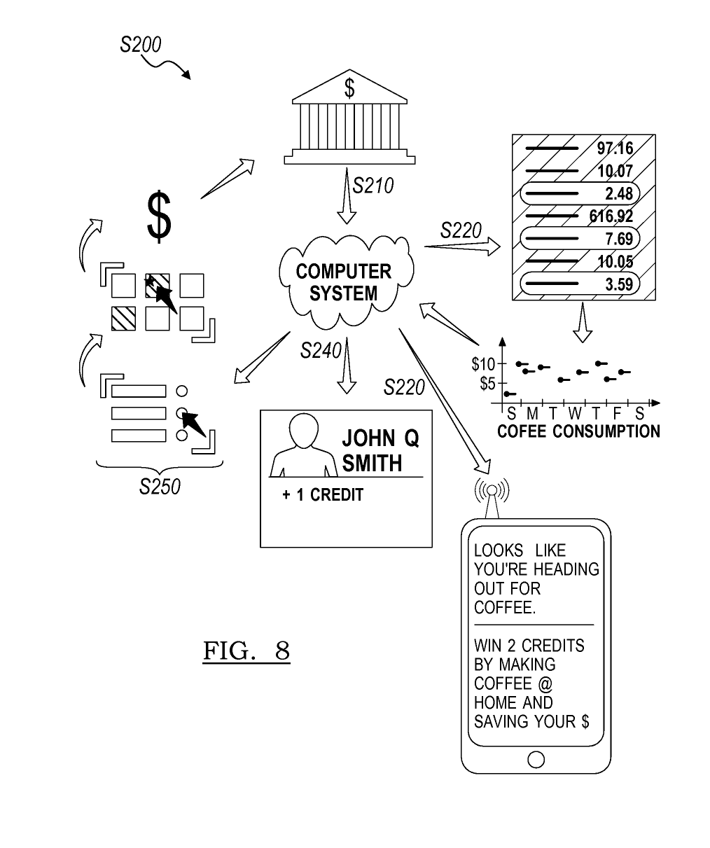

Like method S100 and as shown in FIG. 8, method S200 is preferably implemented by a computer system, such as a cloud-based computer system (e.g., Amazon EC3), a mainframe computer system, a grid-computer system, or any other suitable computer system. The computer system implementing method S200 preferably monitors a financial account of a user, identifies a common purchase made by the user, determines necessity of the purchase, suggests a consumption change for purchased items that are non-necessity goods, identifies user realization of the recommendation, and rewards the user for realizing the recommendation. Like the computer system implementing method S100, the computer system that implements method S200 preferably communicates with the user through a web browser or native application executing on an electronic device, such as a smartphone, a tablet, a laptop computer, a desktop computer, a personal data assistant, or an Internet-enabled personal music player. Method S200 is preferably implemented by an entity separate and distinct from a financial institution (e.g., a bank), although method S200 can alternatively be implemented directly by a bank (e.g., in the form of a customer perk or additional financial service) or by any other suitable entity. Like method S100, method S200 preferably maintains a non-financial account (a ‘gaming account’) for the user such that the user can link a financial account, access financial recommendations, and/or access issued rewards through native applications and/or web browsers executing on multiple mobile and/or static electronic devices.

Generally, method S200 preferably rewards the user for spending less and/or for purchasing fewer goods rather than rewarding the user for spending or purchasing more. Like method S100, method S200 preferably rewards the user by issuing credits that are redeemable for game plays in sweepstakes-type games. The reward therefore preferably does not qualify as ‘consideration’ under applicable sweepstakes and contests laws. Therefore, method S200 preferably does not require a monetary transaction, deposit, purchase, or other transfer of value from the user to the computer system or associated entity to qualify for the reward. The reward is therefore preferably monetarily-free to the user such that method S200 can yield only a net increase in monetary or personal worth for the user. Notably, method S100 preferably monitors financial transactions within the user financial account, such as a repetitive item purchase, but does not require a payment to the computer system or associated entity in exchange for the reward, thus disqualifying monitored and rewarded financial transactions as consideration under relevant sweepstakes and contest law.

Block S210 of method S200 recites monitoring a financial account of a user for an item commonly purchased by the user. Block S210 therefore preferably implements techniques and methods similar to those implemented in Block S110 of method S100 and described above.

Block S210 preferably monitors a checking or credit card account of the user to isolate repetitive purchases, of the same or similar item, made with a debit or credit card associated with the user. Block S210 preferably further analyzes the purchases to determine the nature, necessity, timing, location, and/or other details of the purchases. From these details, Block S210 can determine the financial impact of eliminating, reducing, or replacing the item purchases, and Block S220 preferably generates the behavior change recommendation based upon this derived impact.

In one example, Block S210 isolates multiple purchases between $2.50 and $6.50 made by the user at a particular café (of known location) between 8 AM and 9 AM at least three times a week and identifies the purchase items as coffee-related items. Block S210 can further identify an assumed user need for coffee or related items during weekday mornings but also determine the location, cost, and/or type of coffee-related item to be non-essential to the user's need. In this example and as shown in FIG. 10, Block S220 can generate a recommendation to replace coffee-related purchases at a café with homebrew coffee, which can be substantially less expensive than café-brewed coffee while still fulfilling a caffeine need of the user. In another example, Block S210 isolates repetitive parking and fuel purchases associated with a weekday work commute of the user, determines user departure and arrival locations and times (e.g., through clock and GPS data collected by a mobile device carried by the user), identifies a public transportation alternative to driving, and compares costs and convenience of public and private transportation options for the user. In this example, Block S220 can generate the recommendation for the user that includes a suggestion to switch to a public transportation option that is less expensive and not significantly inconvenient in comparison to private transportation.

Therefore, Block S210 can also include accessing additional user data outside of financial transaction data to improve the accuracy of extracted user consumption details, anticipated user needs, user behavior patterns, user financial models, etc., which can improve the relevance of the recommendation generated for the user in Block S220. In one example, and Block S210 tags user purchases with location data collected through a GPS module in a cellular phone or other mobile device carried by the user. In another example, Block S210 includes collecting user activity through an accelerometer substantially before and after a purchase to correlate a level of user focus and/or energy with the purchase. In yet another example, Block S210 can similarly access user mouse and keystrokes on a work computer to estimate user work output, focus, and/or energy before and after a purchase (e.g., coffee). Additionally or alternatively, Block S210 can extract user purchase data through a digital transaction receipt, such as date, time, and item description. However, Block S210 can function in any other way and can access any other user or transaction-related data to monitor the financial account of the user.

Block S220 of method 5200 recites generating the behavior change recommendation for the user, the recommendation including a suggestion to reduce consumption of the item and a suggestion to transfer money saved from reduced consumption of the item into a savings account. Generally, Block S220 preferably generate the behavior change recommendation by aggregating the nature, necessity, timing, and/or location of item purchases, an estimated financial, emotional, and/or physical impact of eliminating, reducing, or replacing the purchase item, and any other user- and/or item-related data extracted or derived in Block S210. By analyzing data collected in Block S210, including estimated user necessity for the purchase item, possible item alternatives, estimated (net) user financial benefit to reducing or eliminating item consumption, etc., Block S220 can generate the behavior change recommendation that is substantially relevant to the user and has a significant likelihood of user adoption.

The behavior change recommendation generated in Block S220 preferably includes a suggestion for the user to modify consumption behavior to reduce unnecessary spending. For purchases that are determined to be frivolous, excessive, or substantially unnecessary in Block S210, Block S220 preferably generates a recommendation to stop or eliminate consumption of the purchase item. Furthermore, for purchases that are expensive yet fulfill a user need or enable a user function, Block S220 preferably generates a recommendation to reduce consumption of the purchase item and/or replace consumption of the purchase item with a less-expensive alternative. Furthermore, Block S220 can generate the recommendation that includes additional details to minimize effort necessary for the user to adopt the suggested behavior change.

In the example above, for the user who purchases a coffee-related item from a local café several times a week, Block S220 can generate a recommendation to replace café purchases with homebrew coffee. In this example, Block S220 can further recommend particular details for brewing coffee at home or in the office, such as coffee supplier, coffee name, coffee origin, grind size, amount or weight, coffee purchase location, brew method, filter size, water temperature, etc. In another example, Block S210 can isolate weekly purchases in excess of $100 at clothing stores or outlets for a user who is employed outside of the fashion field and who does not have children, and Block S210 further determines many of these user purchases to be in excess. Block S220 can subsequently generate a recommendation for the user to reduce shopping sprees from weekly to monthly, set a maximum monthly clothing expenditure goal, provide locations of local outlet stores and high-end used clothing stores recommended over full-retail centers, and suggest avoiding brands or stores at which the user has a highest likelihood of overspending.

Furthermore, when multiple repeated expenditures are identified in Block S210, Block S220 can prioritize recommendations in order to maximize return (i.e. a behavior change resulting in greatest user savings) without overwhelming the user with too many behavior change suggestions at once. In one example, when Block S210 identifies multiple sub-$5 coffee purchases each week, a $15 movie ticket each week, and bar or club tabs exceeding $150 on Friday and Saturday nights each week over the course of one or more months, Block S220 can prioritize the recommendation to focus first on reducing bar and club tabs to less than $100 total a week. Once the user has achieved this goal, Block S220 can output a second recommendation to shift movie ticket purchases from weekly to biweekly (i.e. every other week), and once the user achieves this goal, Block S220 can output a third recommendation to brew coffee at home rather than purchasing coffee at a café. Generally, Block S220 can prioritize recommendations based upon total item expenditure over a period of time (e.g., per week, per month), estimated user ease or likelihood of adoption, availability and/or quality of alternatives, social implications (e.g., social interactions related to purchases), item necessity, user habits, user location(s), user goals, or any other suitable or relevant factor or user-related or item-related detail.

As shown in FIG. 10, Block S220 further generates a suggestion for the user that to beneficially implement money that would have otherwise been spent on the purchase item. Block S220 preferably recommends that the user deposit the saved money into a savings account, though Block S220 can recommend other options for the saved money. For example, Block S220 can recommend that the user use the saved money to pay off a credit card, augment an investment account, IRA, or 401(k), clear a mortgage or car loan, pay for a better but more expensive health insurance plan, or purchase an alternative but much-needed item (e.g., a new computer, new tires, or a haircut). However, Block S220 can recommend any other use for the money saved when implementing the behavior change suggestion.

As shown in FIG. 8, Block S220 preferably further includes communicating the recommendation to the user. Block S220 can therefore include transmitting the recommendation to the user in the form of a notification in a native application executing on a mobile device carried by the user, a notification or message within the user's gaming account and accessible through a web browser, an email, a SMS text message, a voicemail message, or any other suitable form of communication or through any other communication platform. The recommendation can be communicated to the user according to a preset update schedule (e.g., at loam every morning, 5 pm every Sunday), substantially following an item purchase that boosts a confidence interval greater than a threshold confidence for repetitive purchase of a nonessential item, following each item purchase that neglects a previous behavior change recommendation, or substantially just before an anticipated purchase by the user that would violate a previous purchase recommendation. In one example implementation, Block S220 communicates the recommendation to the user in real time by associating item purchases with a physical location (i.e. a physical vendor location), monitoring the location of the user, and communicating the behavior change recommendation to the user when the location of the user falls within a predetermined distance from the physical location. For example, Block S220 can pair user coffee purchases with a café frequented by the user, can monitor the location of the user through a cellular phone carried by the user (e.g., via a GPS sensor, via triangulation with local cellular towers), and can transmit a recommendation, in the form of a notification, to a smartphone carried by the user, wherein the notification includes a suggestion to wait to brew coffee at home or to opt for a regular black coffee instead of a large cappuccino. In another example implementation, Block S220 tracks user purchase trends including days and times at which the user commonly purchases the item, and Block S220 pushes the recommendation to the user before an anticipated user purchase. For example, Block S220 can track trends in user grocery purchases, determine that the user typically shops on Mondays, Wednesdays, and Fridays between 5 and 6 pm and commonly purchases scallops, filet mignon, and crème brulee. In this example, Block S220 can generate a recommendation to purchase less-expensive food, such as fresh vegetables and chicken, wherein Block S220 transmits the recommendation to the user at 4:45 on Mondays, Wednesdays, and Fridays in anticipation of an upcoming user grocery purchase. However, Block S220 can generate any other recommendation according to any other schema and can communicate the recommendation to the user according to any other schedule, trend, or trigger.

Block S230 of method 5200 recites correlating a monetary deposit into the savings account with reduced consumption of the item. Block S230 preferably tracks a user savings account to identify changes in user savings account deposits over time, including comparing recent financial account activity with historical account activity. By comparing the magnitude of changes in user savings account deposits with a known or typical value of the purchase item, Block S230 can correlate an increase in user savings account deposits with a decrease in user consumption of the purchase item. In the example above in which Block S210 identifies weekly user shopping sprees in excess of $100 each and wherein Block S220 communicates a recommendation to the user to limit shopping sprees to once a month, Block S230 can correlate a $300 increase in month-to-month savings account deposits with user adoption of the recommendation. In another example in which Block S210 identifies common coffee-related purchases and in which Block S220 recommends paying off a credit card balance with money saved by switching from café-brewed coffee to homebrew coffee, Block S230 can correlate an additional $50 payment toward a monthly credit card balance with user adoption of the recommendation.

Block S230 can further access additional user data to augment, verify, and/or determine a magnitude of user adoption of the behavior change recommendation. In one example implementation, Block S230 further includes tracking trends in user purchases across one or more user financial accounts monitored in Block S210. For example, Block S230 can track user credit card purchases at a merchant (e.g., a café) over time and can correlate a decrease in user purchases at the merchant with user adoption of the recommendation. The correlation can further verify a correlation between an increase in user savings (or a decrease in use debt) and user adoption of the recommendation. However, Block S230 can monitor or track any financial account of the user, extract and compare any other current or historical user purchase trend, correlate user monetary deposits with recommendation adoption, and/or verify user recommendation adoption in any other way.

Block S240 of method S200 recites issuing a reward to the user for fulfilling the recommendation. The reward is preferably a nonmonetary credit of no monetary value, as described above, and is preferably issued to the user in digital form, such as through an online gaming account held by the user. Block S240 therefore preferably functions in an manner similar to Block S130 of method 100, and method S200 preferably further implements methods similar to Blocks S170, S160, S140, and S150 of method S100 to receive a user selection for a game play, to exchange a nonmonetary credit for a user game play, to host the game, and to issue a prize to the user in response to a user game play win, respectively. Therefore and as shown in FIGS. 6, 7, and 8, one variation of method S200 can further include Block S250, which recites receiving a user selection for the game within a set of available games, exchanging the credit for a game play within the selected game, and issuing a prize associated with the game to the user in response to a user game play win.

Alternatively, the reward issued to the user in Block S240 can have a monetary value. In one example implementation, Block S240 delivers the reward to the user in digital form, such as a digital coupon for a free cup of coffee or a digital voucher for a plane ticket delivered to the user in the form of a notification accessible through the user's gaming account. In another example implementation, Block S240 handles shipment of a tangible prize to a physical address of the user, such as by collecting the user's address and triggering an MP3 player to be shipped to an address specified by the user. However, Block S240 can function in any other way to issue (e.g., deliver) the reward to the user.

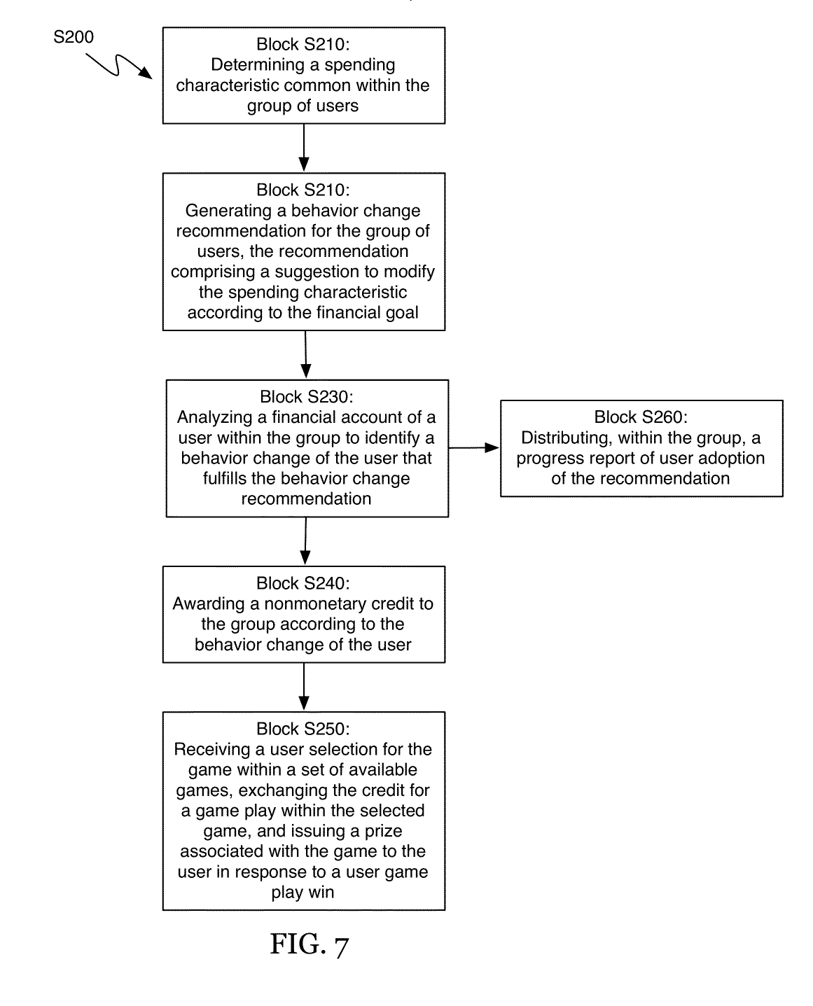

In one variation shown in FIG. 7, method S200 is applied to a group of users, including the user, to incentivize achievement of a financial goal within the group. This variation of method S100 can include: determining a spending characteristic common within the group of users in Block S210; generating a behavior change recommendation for the group of users, the recommendation including a suggestion to modify the spending characteristic according to the financial goal in Block S220; analyzing a financial account of a user within the group to identify a user behavior change that fulfills the behavior change recommendation in Block S230; and awarding a nonmonetary credit to the group according to the behavior change of the user in Block S240. As shown in FIG. 7, this variation can further include distributing, within the group, a progress report of user adoption of the recommendation in Block S260. Method S200 can further include exchanging the credit for a game play and allocating a prize to the group according to a group game play win in Block S250. However, method S200 can be applied to any other number of users to incentivize a financial behavior change in one or more users in the group of users.

The systems and methods of the preferred embodiment can be embodied and/or implemented at least in part as a machine configured to receive a computer-readable medium storing computer-readable instructions. The instructions are preferably executed by computer-executable components preferably integrated with the application, applet, host, server, network, website, communication service, communication interface, hardware/firmware/software elements of a user computer, computer system, or mobile device, or any suitable combination thereof. Other systems and methods of the preferred embodiment can be embodied and/or implemented at least in part as a machine configured to receive a computer-readable medium storing computer-readable instructions. The instructions are preferably executed by computer-executable components preferably integrated by computer-executable components preferably integrated with apparatuses and networks of the types described above. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but any suitable dedicated hardware device can (alternatively or additionally) execute the instructions.

As a person skilled in the art will recognize from the previous detailed description and from the figures and claims, modifications and changes can be made to the preferred embodiments of the invention without departing from the scope of this invention as defined in the following claims.

1-22. (canceled)

23. A method for incentivizing positive asset management, comprising:
linking a first financial account of a first type according to an input from a user;
issuing a credit to a nonmonetary account of the user in response to linking the first financial account;
linking a second financial account of a second type in response to an input from the user;
issuing a credit to the nonmonetary account in response to linking the second financial account;
identifying a monetary transfer between the first financial account and the second financial account, the monetary transfer corresponding to user debt reduction across the first and second financial accounts;
issuing a credit to the nonmonetary account according to the monetary transfer; and
exchanging a credit in the nonmonetary account for a game play within a game selected by the user, the game associated with a prize of a monetary value.

24. The method of claim 23, wherein linking the first financial account comprises accessing the first financial account according to a username, password, and account provider selection entered by the user through a web browser.

25. The method of claim 23, wherein linking the first financial account comprises linking a checking account, wherein linking the second financial account comprises linking a loan account, and wherein identifying the monetary transfer between the first financial account and the second financial account comprises identifying a loan payment from the checking account to the loan account.

26. The method of claim 23, wherein issuing the credit to the nonmonetary account according to the monetary transfer comprises issuing, to the nonmonetary account, a number of credits corresponding to the magnitude of the monetary transfer.

27. The method of claim 23, further comprising hosting a set of games, wherein exchanging the credit in the nonmonetary account for the game play comprises exchanging the credit in the nonmonetary account for the game play according to selection of the game from the set of games.

28. The method of claim 27, wherein hosting the set of games comprises hosting the set of games comprising the game and a second game, the game defining a jackpot drawing associated with a game play comprising a selection of numbers, the second game defining a scratchers game associated with a game play comprising a digital scratch card with a preset win outcome.

29. The method of claim 23, further comprising issuing the prize to the user in response to the game play that results in a win.

30. The method of claim 29, wherein exchanging the credit in the nonmonetary account for the game play comprises initiating an insurance payment from a third-party merchant to an insurance account assigned to the game, the insurance payment of a monetary value less than a monetary value of the prize.

31. The method of claim 30, wherein initiating the payment to the holding account comprises transferring the payment to the holding account that comprises a lottery insurance account associated with the game.

32. The method of claim 30, wherein issuing the prize to the user comprises issuing a prize related to a product offered by the third-party merchant.

33. The method of claim 23, wherein issuing the credit to the nonmonetary account according to the monetary transfer comprises confirming that the monetary transfer does not qualify as consideration under applicable sweepstakes and contests laws.

34. The method of claim 23, wherein identifying the monetary transfer comprises monitoring the first financial account through a read-only Internet connection to a first financial institution associated the first financial account.

35. A method for incentivizing positive asset management, comprising:
linking a first financial account of a first type according to an input from a user;
issuing a credit to a nonmonetary account of the user in response to linking the first financial account;
linking a second financial account of a second type in response to an input from the user;
issuing a credit to the nonmonetary account in response to linking the second financial account;
identifying a monetary transfer between the first financial account and the second financial account through a read-only Internet connection to a first financial institution associated with the first financial account and through a read-only Internet connection to a second financial institution associated with the second financial account;
associating the monetary transfer with user debt reduction across the first and second financial accounts;
issuing a credit, corresponding to the monetary transfer, to the nonmonetary account;
exchanging a credit in the nonmonetary account for a game play within a game selected by the user, the game associated with a prize of a first monetary value;
issuing payment of a second monetary value less than the first monetary value to a holding account assigned to the game; and
issuing the prize to the user in response to a game play win, the prize funded by the holding account.

36. The method of claim 35, wherein issuing payment to the holding account comprises transferring payment to a lottery insurance account affiliated with the game.

37. The method of claim 35, wherein issuing payment to the holding account comprises transferring payment that the second monetary value corresponding to a calculated risk of a game play win and the monetary value of the prize for the game.

38. The method of claim 35, wherein issuing the credit to the account comprises awarding the credit to the user in response to a monetary transfer from the first financial account that comprises a checking account to a second financial account that comprises one of a savings account, a student loan payment, a mortgage payment, and an Individual Retirement Account.

39. A method for effecting a financial behavior change, comprising:
monitoring a financial account of a user for an item commonly purchased by the user;
generating a behavior change recommendation for the user, the recommendation comprising a suggestion to reduce consumption of the item and a suggestion to transfer money, saved from reduced consumption of the item, into a savings account;
correlating a monetary deposit into the savings account with reduced consumption of the item;
in response to the monetary deposit, issuing a credit to a nonmonetary account associated with the user; and
exchanging a credit in the nonmonetary account for a game play within a game selected by the user, the game associated with a prize of a monetary value.

40. The method of claim 39, wherein generating the behavior change recommendation comprises associating the item with a physical location, monitoring a location of a mobile computing device associated with the user, and transmitting the behavior change recommendation to the mobile computing device in response to a location of the mobile computing device within a threshold distance of the physical location associated with the item.

41. The method of claim 40, wherein monitoring the location of the mobile computing device comprises receiving location data from a Global Positioning System sensor arranged within the mobile computing device.

42. The method of claim 39, wherein correlating the monetary deposit with reduced item consumption comprises comparing recent financial account activity with historical account activity.

43. The method of claim 39, further comprising receiving a user selection for the game within a set of available games and issuing a prize associated with the game to the user in response to a game play win.
